(19) United States
(12) Patent Application Publication
(10) Pub. No.: US 2026/0127974 A1
(43) Pub. Date: May 7, 2026

(54) ELECTRONIC EDUCATIONAL TOY FOR CHILDREN

(71) Applicant: Minnan Normal University, Zhangzhou (CN)

(72) Inventors: Xiaoqun WANG, Zhangzhou (CN); Xuecong LIN, Zhangzhou (CN); Ling XU, Zhangzhou (CN)

(21) Appl. No.: 19/032,316

(22) Filed: Jan. 20, 2025

(30) Foreign Application Priority Data
Feb. 28, 2024 (CN) 202410220455.8

(51) Int. Cl. G09B 7/04; A63H 5/00; A63H 33/26; G09B 19/00; G09B 19/02

(52) U.S. Cl. CPC G09B 7/04; G09B 19/0023; G09B 19/025; A63H 5/00; A63H 33/26; A63H 2200/00

(57) ABSTRACT

An electronic educational toy for children, a toy body comprises a body, a rotating block group, a control module and a display module, a setting module is disposed on the body to select different game modes, the rotating block group comprises a plurality of rotating blocks, each of the plurality of rotating blocks is disposed with a plurality of display screens, the plurality of display screens of the plurality of rotating blocks currently in a same plane as the display module is used as an exhibition surface, the control module generates a corresponding data group according to a selected game mode, the plurality of display screens of the plurality of rotating blocks display the corresponding data group, the control module judges whether content currently displayed on the exhibition surface of the plurality of rotating blocks is correct, and the display module displays the content in real time.

### CROSS-REFERENCE TO RELATED APPLICATION

The instant application claims priority to Chinese Patent Application 202410220455.8, filed Feb. 28, 2024. Chinese Patent Application 202410220455.8 is incorporated herein by reference.

### FIELD OF THE DISCLOSURE

The present disclosure relates to the field of toys for children, and in particular relates to an electronic educational toy for children.

### BACKGROUND OF THE DISCLOSURE

Existing educational toys for children are generally divided into two types. A first type is conventional building blocks, small sticks, and the like, which are generally printed with letters, numbers, words, etc. Children form sorts, arithmetic formulas, color schemes, Pinyin, words, phrases, and the like by different combinations of the building blocks. However, the building blocks themselves cannot judge whether results are correct, so children cannot know an answer when playing alone and cannot learn while playing. An educational value of the first type is low. The second type uses learning machines, game consoles, and the like to form the sort, the arithmetic formulas, Pinyin, the words, the phrases, and the like. The second type of the toys cannot be manually operated similar to the building blocks, and it is difficult to mobilize multi-sensory participation of children due to lack of fun. The toys for children should be interesting, so that they can have better interaction with children. Therefore, it is extremely important to design an educational toy in an interesting way that cannot give only a prompt indicating whether the game result is correct, but also enable children to perform the manual operations.

### BRIEF SUMMARY OF THE DISCLOSURE

The present disclosure provides an electronic educational toy for children to overcome the deficiencies of the existing techniques, which is interesting, can mobilize a multi-sensory participation of children, and can give prompts indicating whether a game result is correct, so that children can learn while playing games so as to have an educational value.

In order to solve the aforementioned technical solution, a technical solution of the present disclosure is as follows. An electronic educational toy for children, which comprises a toy body, the toy body comprises a body, a rotating block group, a control module and a display module, a setting module is disposed on the body to select different game modes, the rotating block group comprises a plurality of rotating blocks, the plurality of rotating blocks are rotatably connected to the body, each of the plurality of rotating blocks is disposed with a plurality of display screens, the plurality of display screens of the plurality of rotating blocks currently in a same plane as the display module is used as an exhibition surface, the control module is disposed on the body and is electrically connected to the setting module, the plurality of display screens of each of the plurality of rotating blocks, and the display module, the control module generates a corresponding data group according to a selected game mode of the different game modes, the plurality of display screens of the plurality of rotating blocks display the corresponding data group, the control module judges whether content currently displayed on the exhibition surface of the plurality of rotating blocks is correct according to the selected game mode and outputs a judgment result, and the display module displays the content currently displayed on the exhibition surface of the plurality of rotating blocks in real time and displays the judgment result.

Further, when the selected game mode is a sort mode, the control module determines whether numbers currently disposed on the exhibition surface of the plurality of rotating blocks are arranged in a preset order.

Further, when the selected game mode is an operation mode, the control module judges whether an arithmetic formula currently disposed on the exhibition surface of the plurality of rotating blocks is correct, when the selected game mode is a color scheme mode, the control module judges whether a color scheme currently disposed on the exhibition surface of the plurality of rotating blocks is correct, and when the selected game mode is a mixed mode, the control module judges whether the arithmetic formula and the color scheme currently disposed on the exhibition surface of the plurality of rotating blocks are correct.

Further, when the selected game mode is a text mode, the control module judges whether a spelling currently disposed on the exhibition surface of the plurality of rotating blocks is correct.

Further, a fixed shaft is disposed on the body, the fixed shaft is electrically connected to the control module, the plurality of rotating blocks are rotatably disposed on the fixed shaft and electrically connected to the fixed shaft, and rotation axes of the plurality of rotating blocks align with an axis of the fixed shaft.

Further, inner surfaces of the plurality of rotating blocks are disposed with a plurality of first transmission modules for transmitting data to the plurality of display screens, the plurality of first transmission modules are circumferentially arranged along the inner surfaces of the plurality of rotating blocks, the fixed shaft is disposed with second transmission modules corresponding to the plurality of first transmission modules, and the plurality of first transmission modules are electrically connected to the second transmission modules.

Further, the plurality of first transmission modules comprise a plurality of first data transmission contact points and a plurality of power supply input contact points, and the second transmission modules comprise second data transmission contact points corresponding to the plurality of first data transmission contact points and power supply output contact points corresponding to the plurality of power supply input contact points.

Further, the inner surfaces of the plurality of rotating blocks are respectively disposed with positioning grooves at positions of the plurality of first transmission modules, the fixed shaft is disposed with positioning ratchets corresponding to the positioning grooves, and the positioning ratchets cooperate with the positioning grooves so as to limit rotation of the plurality of rotating blocks on the fixed shaft in one direction.

Further, the display module comprises a primary display screen and a lock symbol in the primary display screen, the primary display screen synchronously displays the content currently displayed on the exhibition surface of the plurality of rotating blocks, the lock symbol displays “unlocked” when the content is correct, and the lock symbol remains “locked” when the content is wrong.

Further, the setting module comprises a power switch button, a start/reset button, a mode selection button, a difficulty selection button and a confirmation button, the electronic educational toy further comprises a speaker, the speaker is electrically connected to the control module, and the speaker is used to give a sound prompt for the control module to judge whether the content currently displayed on the exhibition surface of the plurality of rotating blocks is correct.

Compared with the existing techniques, the present disclosure has the following advantages.

1. The rotating block group of the present disclosure comprises a plurality of rotating blocks, and the plurality of rotating blocks are rotatably connected to the body. Each of the plurality of rotating blocks is disposed with a plurality of display screens, and the plurality of display screens of the plurality of rotating blocks currently in the same plane as the display module is used as the exhibition surface. The control module judges whether the content current on the exhibition surface of the plurality of rotating blocks is correct according to the game mode and outputs a result of the judgment. The display module displays the content current on the exhibition surface of the plurality of rotating blocks in real time and displays the result of the judgment. The present disclosure comprises the plurality of rotating blocks, so that a child needs to rotate the plurality of rotating blocks to output a result of the game when playing the game, which increases a fun of the game, has better interaction with the child, mobilizes a multi-sensory participation of the child, enhances an educational value, judges whether the result is correct according to the game mode through the control module, and then outputs the result of the judgment through the display module, thereby solving the problem of whether the result is correct when the building blocks are combined for the game that cannot be judged in the existing techniques.

2. The game modes of the present disclosure comprise the sort mode, the operation mode, the color scheme mode, the mixed mode, the text mode, and the like, and children can select a variety of the game modes, so that playability and fun of the present disclosure can be effectively improved, and a cognition of children according to colors, numbers, space, and other aspects can be trained.

3. The display module of the present disclosure comprises a primary display screen and a lock symbol in the primary display screen, and the primary display screen synchronously displays the content currently displayed on the exhibition surface of the plurality of rotating blocks. The lock symbol indicates “unlocked” or “locked”, which gives a result of the judgment, so that a game operation process and the judgment regarding whether the result is correct are more intuitive and clear.

4. The present disclosure further comprises a speaker, so that it is more convenient to know whether the game result is correct.

The present disclosure is further described below in conjunction with the accompanying drawings and embodiments, but the electronic educational toy for children of the present disclosure is not limited to the embodiments.

### BRIEF DESCRIPTION OF THE DRAWINGS

FIG. 1 illustrates a flow chart of Embodiment 1 of the present disclosure;

FIG. 2 illustrates a front view of Embodiment 1 of the present disclosure;

FIG. 3 illustrates a perspective view of a rotating block and a fixed shaft of Embodiment 1 of the present disclosure;

FIG. 4 illustrates a sectional view of the rotating block of Embodiment 1 of the present disclosure;

FIG. 5 illustrates a front view of the fixed shaft of Embodiment 1 of the present disclosure;

FIG. 6 illustrates a diagrammatic view of Embodiment 1 of the present disclosure when a gaming mode is in a sort mode;

FIG. 7 illustrates a diagrammatic view of Embodiment 1 of the present disclosure when the gaming mode is in an operation mode;

FIG. 8 illustrates a perspective view of a fixed shaft of Embodiment 2 of the present disclosure; and

FIG. 9 illustrates a front view of the fixed shaft of Embodiment 2 of the present disclosure.

### DETAILED DESCRIPTION OF THE EMBODIMENTS

In the description of the present disclosure, it should be noted that terms, such as “upper” and “lower”, indicate orientations or positional relationships based on orientations or positional relationships shown in the accompanying drawings and are merely used to easily describe the present disclosure, rather than indicating or implying that a referenced device or element should have a particular orientation or be constructed and operated with a particular orientation, and therefore should not to be understood as a limitation of the protective scope of the present disclosure. The specific meaning of the terms in the present disclosure can be understood in specific conditions for those of ordinary skill in the art.

In addition, in the description of the present disclosure, unless otherwise expressly specified and limited, it is noted that “multiple” refers to two or more. In the description of the present disclosure, unless otherwise expressly specified and limited, it is noted that terms, such as “mounted”, “provided with”, and “connected”, should develop a broad understanding, for example, “connection” can be a fixed connection, a detachable connection, an integrated connection, a mechanical connection, an electrical connection, a direct connection, an indirect connection via an intermediate medium, or a communication between inner portions of two elements, and the specific meaning of the terms in the present disclosure can be understood in specific conditions for those of ordinary skill in the art.

### Embodiment 1

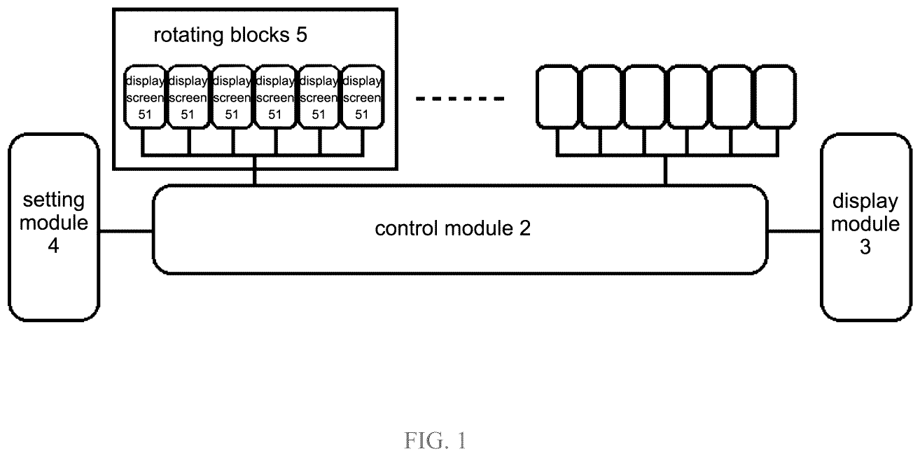

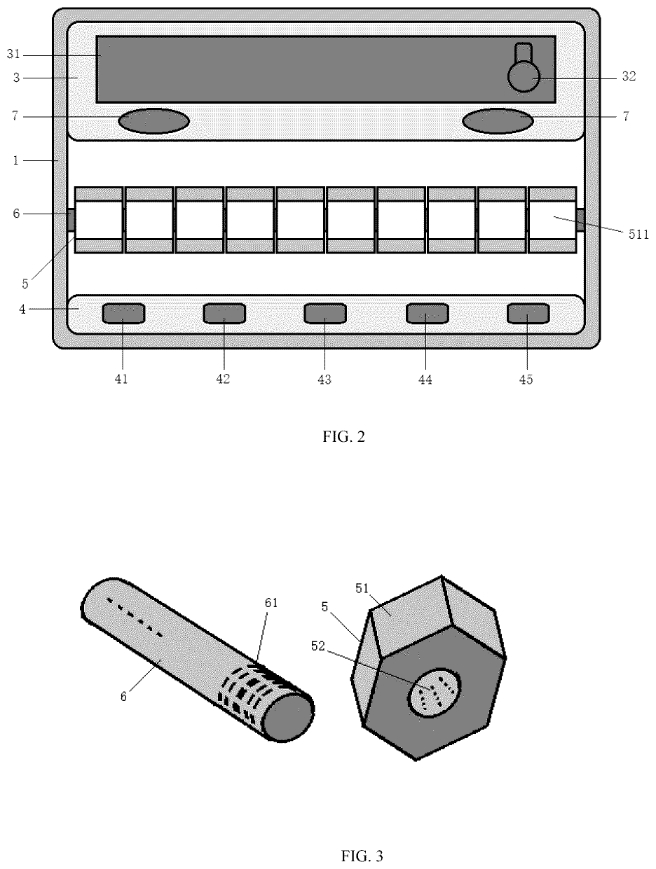

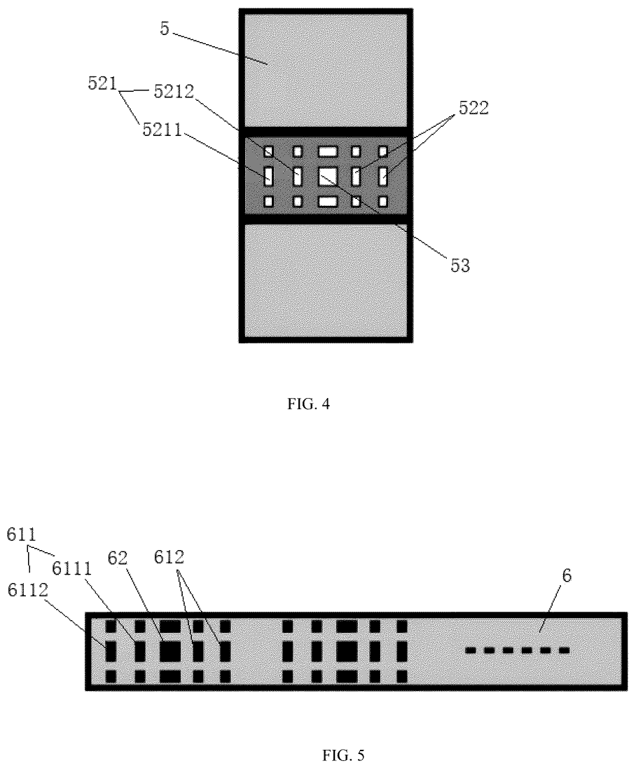

Referring to FIGS. 1-7, an electronic educational toy for children of the present disclosure comprises a toy body, and the toy body comprises a body 1, a rotating block group, a control module 2, and a display module 3. A setting module 4 configured for selecting different game modes is disposed on the body 1. The rotating block group comprises a plurality of rotating blocks 5. The plurality of rotating blocks 5 are rotatably connected to the body 1, and a plurality of display screens 51 are disposed on each of the plurality of rotating blocks 5. The plurality of display screens 51 of the plurality of rotating blocks 5 that are currently on a same plane as the display module 3 is used as an exhibition surface 511. The control module 2 is disposed on the body 1 and is electrically connected to the setting module 4, the plurality of display screens 51 of each of the plurality of rotating blocks 5, and the display module 3. The control module 2 generates a corresponding data group according to a selected game mode of the different game modes, and the plurality of display screens 51 of the plurality of rotating blocks 5 display the corresponding data group. The control module 2 judges whether content currently on the exhibition surface 511 of the plurality of rotating blocks 5 is correct according to the selected game mode and outputs a judgment result. The display module 3 displays the content currently on the exhibition surface 511 of the plurality of rotating blocks 5 in real time and displays the judgment result.

A fixed shaft 6 is disposed on the body 1, and the fixed shaft 6 is electrically connected to the control module 2. The plurality of rotating blocks 5 are rotatably disposed on the fixed shaft 6 and are electrically connected to the fixed shaft 6, and rotation axes of the plurality of rotating blocks 5 align with an axis of the fixed shaft 6.

Inner surfaces of the plurality of rotating blocks 5 are disposed with a plurality of first transmission modules 52 for transmitting data to the plurality of display screens 51, and the plurality of first transmission modules 52 are circumferentially arranged along the inner surfaces of the plurality of rotating blocks 5. Second transmission modules 61 corresponding to the plurality of first transmission modules 52 is disposed on the fixed shaft 6, and the plurality of first transmission modules 52 are electrically connected to the second transmission modules 61.

Each of the plurality of first transmission modules 52 comprises a plurality of first data transmission contact points 521 and a plurality of power supply input contact points 522, and the second transmission modules 61 comprise second data transmission contact points 611 corresponding to the plurality of first data transmission contact points 521 and power supply output contact points 612 corresponding to the plurality of power supply input contact points 522.

An inner surface of the inner surfaces on each of the plurality of rotating blocks 5 comprises positioning grooves 53 corresponding to the plurality of first transmission modules 52, and positioning ratchets 62 corresponding to the positioning grooves 53 are disposed on the fixed shaft 6. The positioning ratchets 62 cooperates with the positioning grooves 53 and limits a corresponding one of the plurality of rotating blocks 5 to rotate on the fixed shaft 6 in a direction. The plurality of first data transmission contact points 521 and the positioning grooves 53 are arranged along an axial direction of each of the plurality of rotating blocks 5.

The display module 3 comprises a primary display screen 31 and a lock symbol 32 in the primary display screen 31. The primary display screen 31 displays content currently displayed on the exhibition surface 511 of the plurality of rotating blocks 5 synchronously. The control module 2 judges whether the content currently displayed on the exhibition surface 511 of the plurality of rotating blocks 5 is correct. The lock symbol 32 displays an unlocked state when the content is judged as wrong, and the lock symbol 32 remains in a locked state when the content is judged as correct.

The setting module 4 comprises a power switch button 41, a start/reset button 42, a mode selection button 43, a difficulty selection button 44, and a confirmation button 45. The present disclosure further comprises a speaker 7, and the speaker 7 is electrically connected to the control module 2 so as to provide a voice prompt when the control module 2 judges whether the content currently displayed on the exhibition surface 511 of the plurality of rotating blocks 5 is correct or wrong.

In this embodiment, the rotating block group comprises ten rotating blocks 5, and each of the ten rotating blocks 5 is disposed with six display screens 51 of the plurality of display screens 51. Six first transmission modules 52 and six positioning grooves 53 are arranged an inner surface of each of the ten rotating blocks 5 along a circumferential direction of each of the ten rotating blocks 5, and each of the six first transmission modules 52 comprises two of the plurality of first data transmission contact points 521 and two of the plurality of power supply input contact points 522. The two of the plurality of first data transmission contact points 521 are divided into one input and one output. In order for easy distinction, the two of the plurality of first data transmission contact points 521 are named as a first data input contact point 5211 and a first data output contact point 5212. The second data transmission contact points 611 and the positioning ratchets 62 on the fixed shaft 6 correspond to the plurality of first data transmission contact points 521 and the positioning grooves 53 of each of the ten rotating blocks 5. That is, the second data transmission contact points 611 are divided into one input and one output. In order for easy distinction, the second data transmission contact points 611 are named as a second data input contact point 6111 and a second data output contact point 6112. The first data input contact point 5211 corresponds to the second data output contact point 6112, and the first data output contact point 5212 corresponds to the second data input contact point 6111. The plurality of first data transmission contact points 521 and the second data transmission contact points 611 are serial communication interfaces that enable bidirectional transmission to achieve data feedback, and each of the serial communication interfaces has a fixed number to selectively open or close data transmission of any of the serial communication interfaces by a programming of a control end. Therefore, by closing one or more of the serial communication interfaces other than corresponding to current data displayed on the exhibition surface 511 of the plurality of rotating blocks 5, only the data currently displayed on the exhibition surface 511 of the plurality of rotating blocks 5 is transmitted back, so that the primary display screen 31 can display the content currently displayed on the exhibition surface 511 of the plurality of rotating blocks 5 synchronously.

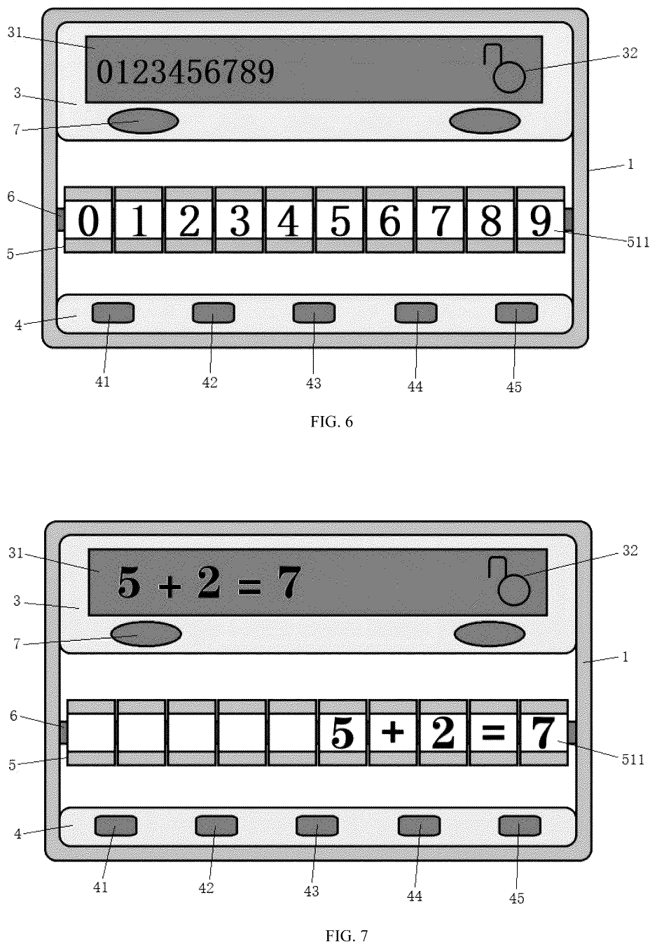

In this embodiment, the different game modes comprise following modes:
1. A sort mode: each of the six display screens 51 of each of the plurality of rotating blocks 5 randomly generates random numbers, and one or more correct numbers is found by rotating one or more of the plurality of rotating blocks 5 in an answer area. After the plurality of rotating blocks 5 are arranged in a sort from small to large or from large to small, the control module 2 judges whether the numbers currently displayed on the exhibition surface 511 of the plurality of rotating blocks 5 are arranged in a set order. If the sort is correct, the lock symbol 32 displays “unlocked”, and the speaker 7 emits a sound prompt indicating the sort is correct, as shown in FIG. 5.
2. An operation mode: the exhibition surface 511 current on the plurality of rotating blocks 5 generates an arithmetic formula, and addition, subtraction, multiplication, and division operations and digits can be selected by the setting module 4. A calculation answer is obtained by rotating the one or more of the plurality of rotating blocks 5 in the answer area. The control module 2 judges whether the arithmetic formula current on the exhibition surface 511 of the plurality of rotating blocks 5 is correct. If the arithmetic formula is correct, the lock symbol 32 displays “unlocked”, and the speaker 7 emits the sound prompt indicating the arithmetic formula is correct, as shown in FIG. 6.
3. Color scheme mode: the exhibition surface 511 current on the plurality of rotating blocks 5 generates a set of colors (a number of the colors can be 2-4), and a mixed color is selected by rotating the one or more of the plurality of rotating blocks 5 in the answer area. Alternatively, the exhibition surface 511 current on the plurality of rotating blocks 5 generates the mixed color, and a color scheme is selected by rotating the one or more of the plurality of rotating blocks 5 in the answer area. The control module 2 judges whether the color scheme current on the exhibition surface 511 is correct. If the color scheme is correct, the lock symbol 32 displays “unlocked”, and the speaker 7 emits the sound prompt indicating the color scheme is correct.
4. Mixed mode: the exhibition surface 511 current on the plurality of rotating blocks 5 generates the arithmetic formula and the set of colors synchronously, and the one or more of the plurality of rotating blocks 5 in the answer area rotate so that the plurality of display screens 51 that satisfy the color scheme and the calculation answer are located on the exhibition surface 511. The control module 2 judges whether the arithmetic formula and the color scheme currently displayed on the exhibition surface 511 are correct. If the arithmetic formula and the color scheme are correct, the lock symbol 32 displays “unlocked”, and the speaker 7 emits the sound prompt indicating the arithmetic formula and the color scheme are correct.
5. Text mode: Pinyin or English letters of a text are spelled by rotating the one or more of the plurality of rotating blocks 5 in the answer area, and the control module 2 judges whether the spelling currently displayed on the exhibition surface 511 is correct. If the spelling is correct, the lock symbol 32 displays “unlocked”, and the speaker 7 emits the sound prompt indicating the spelling is correct.
6. Other custom modes, such as jigsaw puzzles, shape puzzles, word forming, etc. are contemplated.

Specifically, the one or more of the plurality of rotating blocks 5 in the answer area are not fixed and depend on a selection of the different game modes and game difficulties.

A specific operation of the electronic educational toy for children of the present disclosure takes the sort mode as an example:
1. The power switch button 41 is pressed to turn on the electronic educational toy for children.
2. The sort mode is selected through the mode selection button 43.
3. A game difficulty (such as a number of the digits to be sorted) is selected through the difficulty selection button 44.
4. The start/reset button 42 is pressed, and each of the plurality of display screens 51 of each of the plurality of rotating blocks 5 randomly generates messy numbers.
5. The one or more of the plurality of rotating blocks 5 in the answering area rotate multiple times to find correct numbers, so that the one or more of the plurality of display screen 51 with the correct numbers are located on the exhibition surface 511 and arranged according to the preset order.
6. After the sort is complete, the confirmation button 45 is pressed for confirmation. The control module 2 judges whether the numbers currently displayed on the exhibition surface 511 are arranged in the preset order. If the sort is correct, the lock symbol 32 displays “unlocked”, and the speaker 7 emits the sound prompt indicating the sort is correct. If the sort is wrong, the lock symbol 32 remains “locked”, and the speaker 7 emits the sound prompt indicating the sort is incorrect. At this time, the start/reset key 42 is pressed to reset and restart the game.

The electronic educational toy for children of the present disclosure can train a recognition of children, such as colors, numbers, space, in a form of games, provides children appropriate enlightenment input, greatly promotes a development of logical thinking ability of children, is interesting, has better interaction with children, mobilize a multi-sensory participation of children, and is educational.

### Embodiment 2

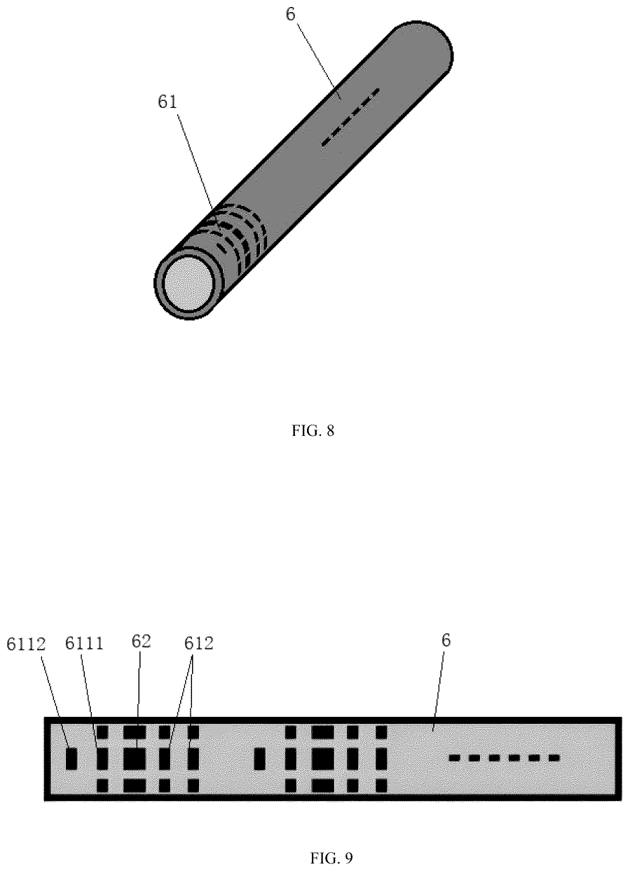

Referring to FIGS. 8 and 9, the electronic educational toy for children of the present disclosure differs from Embodiment 1 in that the second transmission modules 61 on the fixed shaft 6 merely corresponding to the exhibition surface 511 comprises two of the second data transmission contact points 611, which are named as the second data input contact point 6111 and the second data output contact point 6112. The second transmission modules 61 corresponding to the other of the plurality of display screens 51 has only one of the second data transmission contact points 611, i.e., the second data output contact point 6112, so that only the data of the plurality of rotating blocks 5 currently displayed on the exhibition surface 511 can be transmitted back, so that the primary display screen 31 synchronously displays the content currently displayed on the exhibition surface 511 of the plurality of rotating blocks 5.

The uninvolved parts of the electronic educational toy for children of the present disclosure are the same as the existing techniques or can be implemented by the existing techniques.

The aforementioned embodiments are merely used to further describe the electronic educational toy for children of the present disclosure. However, the present disclosure is limited to the embodiments. It is intended the protective scope of the technical solution of the present disclosure cover any simple modification, equivalent variation and refinement of the aforementioned embodiments provided that they are made based on the technical substantive of the present disclosure.

What is claimed is:

1. An electronic educational toy for children, comprising:
a toy body, wherein:
the toy body comprises a body, a rotating block group, a control module, and a display module,
a setting module is disposed on the body to select different game modes,
the rotating block group comprises a plurality of rotating blocks,
the plurality of rotating blocks are rotatably connected to the body,
each of the plurality of rotating blocks is disposed with a plurality of display screens,
the plurality of display screens of the plurality of rotating blocks currently in a same plane as the display module is used as an exhibition surface,
the control module is disposed on the body and is electrically connected to the setting module, the plurality of display screens of each of the plurality of rotating blocks, and the display module,
the control module generates a corresponding data group according to a selected game mode of the different game modes,
the plurality of display screens of the plurality of rotating blocks display the corresponding data group,
the control module judges whether content currently displayed on the exhibition surface of the plurality of rotating blocks is correct according to the selected game mode and outputs a judgment result, and
the display module displays the content currently displayed on the exhibition surface of the plurality of rotating blocks in real time and displays the judgment result.

2. The electronic educational toy for children according to claim 1, wherein:
when the selected game mode is a sort mode, the control module determines whether numbers currently disposed on the exhibition surface of the plurality of rotating blocks are arranged in a preset order.

3. The electronic educational toy for children according to claim 1, wherein:
when the selected game mode is an operation mode, the control module judges whether an arithmetic formula currently disposed on the exhibition surface of the plurality of rotating blocks is correct,
when the selected game mode is a color scheme mode, the control module judges whether a color scheme currently disposed on the exhibition surface of the plurality of rotating blocks is correct, and
when the selected game mode is a mixed mode, the control module judges whether the arithmetic formula and the color scheme currently disposed on the exhibition surface of the plurality of rotating blocks are correct.

4. The electronic educational toy for children according to claim 1, wherein:
when the selected game mode is a text mode, the control module judges whether a spelling currently disposed on the exhibition surface of the plurality of rotating blocks is correct.

5. The electronic educational toy for children according to claim 1, wherein:
a fixed shaft is disposed on the body,
the fixed shaft is electrically connected to the control module,
the plurality of rotating blocks are rotatably disposed on the fixed shaft and electrically connected to the fixed shaft, and
rotation axes of the plurality of rotating blocks align with an axis of the fixed shaft.

6. The electronic educational toy for children according to claim 5, wherein:
inner surfaces of the plurality of rotating blocks are disposed with a plurality of first transmission modules for transmitting data to the plurality of display screens,
the plurality of first transmission modules are circumferentially arranged along the inner surfaces of the plurality of rotating blocks,
the fixed shaft is disposed with second transmission modules corresponding to the plurality of first transmission modules, and
the plurality of first transmission modules are electrically connected to the second transmission modules.

7. The electronic educational toy for children according to claim 6, wherein:
the plurality of first transmission modules comprise a plurality of first data transmission contact points and a plurality of power supply input contact points, and
the second transmission modules comprise second data transmission contact points corresponding to the plurality of first data transmission contact points and power supply output contact points corresponding to the plurality of power supply input contact points.

8. The electronic educational toy for children according to claim 6, wherein:
the inner surfaces of the plurality of rotating blocks are respectively disposed with positioning grooves at positions of the plurality of first transmission modules,
the fixed shaft is disposed with positioning ratchets corresponding to the positioning grooves, and
the positioning ratchets cooperate with the positioning grooves so as to limit rotation of the plurality of rotating blocks on the fixed shaft in one direction.

9. The electronic educational toy for children according to claim 1, wherein:
the display module comprises a primary display screen and a lock symbol in the primary display screen,
the primary display screen synchronously displays the content currently displayed on the exhibition surface of the plurality of rotating blocks,
the lock symbol displays “unlocked” when the content is correct, and
the lock symbol remains “locked” when the content is wrong.

10. The electronic educational toy for children according to claim 1, wherein:
the setting module comprises a power switch button, a start/reset button, a mode selection button, a difficulty selection button and a confirmation button,
the electronic educational toy further comprises a speaker,
the speaker is electrically connected to the control module, and
the speaker is used to give a sound prompt for the control module to judge whether the content currently displayed on the exhibition surface of the plurality of rotating blocks is correct.
